(19) United States
(12) Patent Application Publication
(10) Pub. No.: US 2004/0262462 A1
(43) Pub. Date: Dec. 30, 2004

(54) One-piece molded clamp

(76) Inventors: Donald J. Polak, Nashville, TN (US); Thomas J. Bush, Canton Center, CT (US)

Correspondence Address: Cohen & Grigsby, P.C., 15th Floor, 11 Stanwix Street, Pittsburgh, PA, 15222, US

(21) Appl. No.: 10/608,735

(22) Filed: Jun. 27, 2003

(51) Int. Cl. F16L 3/08

(52) U.S. Cl. 248/74.1

(57) ABSTRACT

The invention is a clamp that possess a novel one-piece design wherein all components of the clamp are unitary with one another. The clamp has two jaws that are unitary with one another. The inner surface of the jaws have protrusions which come into contact with the device being gripped and stabilize the device being gripped for transport on a vehicle. A tension strap extends from one of the jaws that is able to be releasably engaged with notches that are formed in the other jaw.

### FIELD OF THE INVENTION

The invention relates to clamping devices. Specifically, the invention relates to molded clamps that can be mounted on vehicles, the clamps being used for securing objects, such as tools, for transport.

### BACKGROUND OF THE INVENTION

Presently, several options exists for securing to vehicles objects (such as tools having handles, i.e., shovels, brooms, axes, and the like) in order to transport the objects. But the present options are cumbersome, difficult to install, expensive, or contain too many component parts. For instance, metal spring operated clamps can be used to secure to objects to a vehicle, but those clamps are prone to corrode. And if the vehicle is traveling over rough terrain, the multiple component parts of such clamps may become disturbed causing the clamping mechanism to fail. Other available options include tie down mechanisms wherein a nylon or canvas strap must be placed around the object and engaged to the vehicle by any number of fastening means. Other devices include a combination of mounting brackets wherein the object placed within the brackets and caps having a wing nut / bolt combination placed therethrough and wherein the caps are clamped down on the objects by tightening the wing nut. Such devices require extensive hardware, and are complicated to operate and install.

With respect to the pipe stand-off aspect of the invention, metal pipe stand offs are ill equipped to handle the corrosive effects of the elements and leakage, especially in the marine environment. Further, metal pipe stand offs require additional hardware and labor to install.

### SUMMARY OF THE INVENTION

The invention is a novel one-piece molded clamp. The one-piece molded clamp possesses a novel one-piece design wherein all components of the clamp are unitary with one another. The clamp has two jaws that are unitary with one another. The inner surface of the jaws have protrusions which come into contact with the device being gripped and stabilize the device being gripped for transport on a vehicle. A tension strap extends from one of the jaws and is able to be releasably engaged with notches that are formed in the other jaw.

By possessing a unitary design, that is a one-piece design, it is an object of the present invention to provide a clamp that can be easily mounted on any surface, particularly that of a vehicle, for the safe and stable transport of tools and equipment.

It is another object of the invention to provide a clamp with superior gripping capabilities, which are particularly useful for the safe and stable transport of tools and equipment.

It is a further object of the invention to provide a one-piece unitary design such that the clamp can be manufactured quickly and at a lower cost relative to clamps that possess multiple parts or a non-unitary design.

It is still a further object of the invention to provide a pipe stand off that is easily installed.

It is still a further object of the invention to provide a pipe stand off that is resistant to corrosion, particularly in the marine environment.

### BRIEF DESCRIPTION OF THE DRAWINGS

FIG. 1 is a side view of the invention with the tension strap disengaged.

FIG. 2 is a depiction of the invention as in FIG. 1 but rotated clockwise 90 degrees.

FIG. 3 is an isometric view of the invention with the tension strap engaged.

FIG. 4 is an isometric view of the invention with the tension strap disengaged.

### DETAILED DESCRIPTION OF THE PREFERRED EMBODIMENT

The invention is a one-piece molded clamp that can be used to a variety of tubular or rod-like objects including but not limited to tools such as shovels, hammers, brooms, and any tool that has a long handle. In an embodiment, the clamp of the present invention can be mounted on any vertical, oblique, or horizontal surface of a vehicle to secure various objects for transport. The invention can also be used as a pipe stand off and is particularly useful as such in marine environments.

The one-piece clamp is molded. It can be made out of rubber, a flexible thermoplastic, or a synthetic rubber. In a preferred embodiment, the one-piece clam is made out of EPDM. The benefits of such materials are that they are corrosion resistant and are flexible yet provide the requisite tension to clamp an object in place.

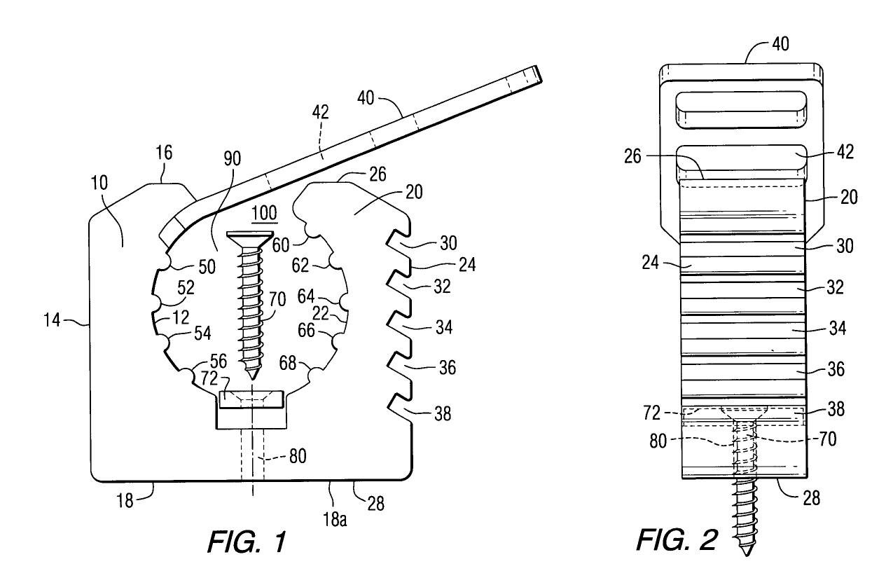

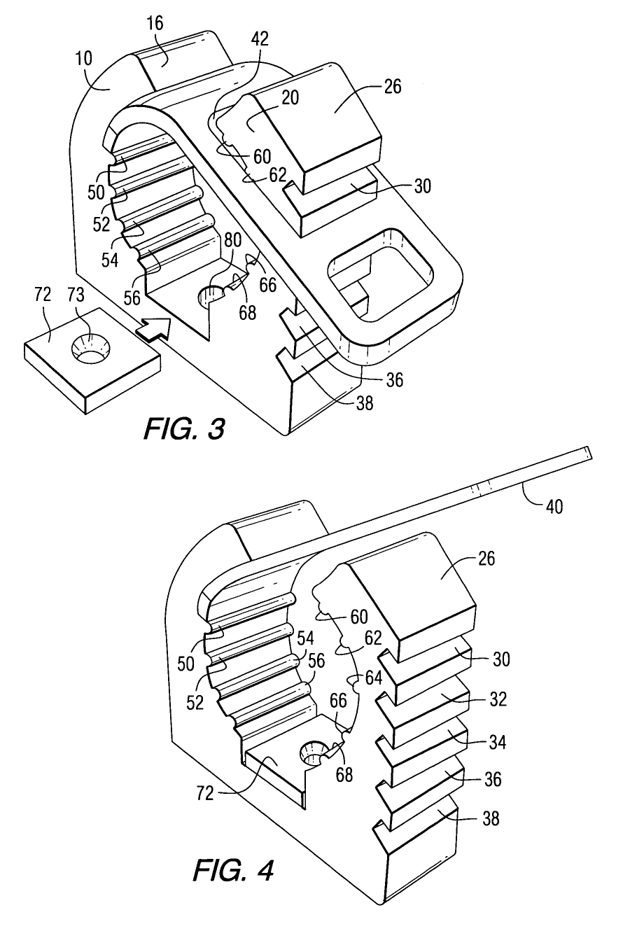

FIGS. 1 through 4 show the preferred embodiment of the one-piece molded clamp according to the present invention. FIGS. 1, 2, and 4 show the one-piece molded clamp in a disengaged state. FIG. 3 shows the one-piece molded clamp in an engaged state. Referring to FIG. 1, the one-piece molded clamp is shown wherein a first jaw 10 is unitary with a second jaw 20. There is no separation between the first and second jaw as they are the sum parts, but unitary parts, of the whole unitary molded clamp. The jaws, together, define a cavity 90 with an opening 100 into which the object to be secured, for example a shovel or—in the embodiment wherein the invention is used as a pipe stand off—a pipe is placed. Each jaw has an inward facing surface 12, 22, an outward facing surface 14, 24, a first end 16, 26, and a second end 18, 28. The inward facing surfaces 12, 22 of the first and second jaws are the portions of the one-piece molded clamp that face the outer perimeter of an object to be secured. With respect to the object to be secured, the viewer of FIG. 1 can imagine the object, for instance the handle of a broom, having a perimeter facing each jaw and being disposed in such a way that the handle would come straight out of the page perpendicular to the plane of the cavity 90 of the one-piece molded clamp in FIG. 1. The first ends 16, 26 are the ends of the jaws most near the opening 100 of the cavity 90. Ends 18, 28 are opposite ends 16, 26 and face the surface onto which the one-piece molded clamp can be mounted. In the preferred embodiment, protrusions 50, 52, 54, 56, 60, 62, 64, 66, 68 are unitarily formed on the inward facing surfaces 12, 22 of each jaw 10, 20, the protrusions ultimately contacting the object that is to be secured. The second jaw 20 has at least one notch 30, 32, 34, 36, 38 formed therein into which a tension strap 40 having at least one aperture 42, can be releaseably engaged. Tension strap 40 is unitarily formed with the first jaw 10 and, in a preferred embodiment, the tension strap extends from the inward facing surface 12 of the first jaw 10. A sheet metal screw 70 (FIGS. 1 and 2 only) and washer 72 having a hole 73 can be used to secure the clamp the body of a vehicle via hole 80. It will be noted, however, by the skilled artisan, that any fastening means could be used to secure the mounting end 18a of the unitary molded clamp to any surface, and the choice of fastening means will depend on the surface to which the one-piece molded clamp is to be mounted.

FIG. 2 shows the one-piece molded clamp in FIG. 1 rotated clockwise 90 degrees. This figure more clearly shows the aperture 42 in the tension strap 40. FIG. 2 also shows the notches 30, 32, 34, 36, 38 into which the tension strap can be releaseably engaged by upon passing one of the at least one apertures 42 over the second end 26 of the second jaw 20.

FIGS. 3 and 4 are isometric views of the one-piece molded clamp when the tension strap 40 is releaseably engaged (FIG. 3) and again disengaged (FIG. 4). The tension strap is passed over the first end 26 of the second jaw 20. The at least one aperture 42 in the tension strap allows for this function. Upon passing the tension strap over the second jaw 20 (this can also be described as passing the jaw through the aperture in the tension strap), the strap can be realeaseably engaged into one of the at least one notches 30, 32, 34, 36, 38 in the outward facing surface 24 (FIGS. 1 and 2) of the second jaw 20. Which notch is used will depend on the perimeter size of the object to be secured and the desired amount of clamp force the user will wish to apply. Due to the flexible nature of the one-piece molded clamp, particularly the tension strap 40 and the jaws 10, 20, objects having a perimeter size greater than the perimeter of the of the cavity 90 can be accommodated with the tension strap, because the jaws will flex and the tension strap will provide the difference in the perimeter length needed to accommodate the object.

Accordingly, it should be readily appreciated that the above uses of the present invention have many practical applications. Additionally, although the preferred embodiment has been illustrated and described, it will be obvious to those skilled in the art that various modifications can be made without departing from the spirit and scope of this invention. Such modifications are to be considered as included in the following claims unless the claims expressly recite differently.

1. A one-piece molded clamp comprising:
a) a first jaw having an inward facing surface, an outward facing surface, a first end, and a second end;
b) a second jaw unitarily formed with said first jaw, said second jaw having an inward facing surface, an outward facing surface, a first end, and a second end;
c) at least one notch in said outward facing surface of said second jaw; and
d) a tension strap unitarily formed with said first jaw said tension strap having at least one through-aperture through which said second jaw is able to pass, said tension strap is able to be releasably engaged with said at least one said notch upon passing said first end of said second jaw through said aperture.

2. The one-piece molded clamp of claim 1 further comprising at least one protrusion on said inward facing surfaces of said first and said second jaws.

3. The one-piece molded clamp of claim 2, wherein said at least one protrusion is unitarily formed with said inward facing surfaces of said first and second jaws.

4. The one-piece molded clamp of claim 1 wherein said tension strap extends from said inward facing surface of said first jaw.

5. The one-piece molded clamp of claim 1 wherein said second ends of said first and second jaws further comprise means to mount said clamp on a surface.

6. The one-piece molded clamp of claim 5 wherein said surface is a body of a vehicle.

7. The one-piece molded clamp of claim 1 wherein said clamp is made of a polymer.

8. The one-piece molded clamp of claim 1 wherein said clamp is made of rubber.

9. The one-piece molded clamp of claim 1 wherein said clamp is made of a synthetic rubber.

10. (canceled)
